(19) United States
(12) Patent Application Publication
(10) Pub. No.: US 2014/0333591 A1
(43) Pub. Date: Nov. 13, 2014

(54) SALIENT CONTROL ELEMENT AND MOBILE DEVICE WITH SALIENT CONTROL ELEMENT

(71) Applicants: Cynthia Sue Bell, Kirkland, WA (US); Rod G. Fleck, Bellevue, WA (US); Thamer Abanami, Seattle, WA (US)

(72) Inventors: Cynthia Sue Bell, Kirkland, WA (US); Rod G. Fleck, Bellevue, WA (US); Thamer Abanami, Seattle, WA (US)

(21) Appl. No.: 14/054,669

(22) Filed: Oct. 15, 2013

Related U.S. Application Data
(60) Provisional application No. 61/821,641, filed on May 9, 2013.

(51) Int. Cl. G06F 3/023

(52) U.S. Cl. CPC G06F 3/0238
USPC 345/184

(57) ABSTRACT

A salient control element for a mobile device comprises at least one button actuatable by a user to execute a mobile device function. The button has at least a first active state in which the button is extended or retracted relative to a surrounding surface and a second inactive state in which the button is substantially flush with the surrounding surface. The button is reconfigurable between the active state and the inactive state based upon a triggering event. The triggering event comprises at least one of receiving signals indicating a position, motion or orientation of the device, signals indicating a mode of operation or time, signals indicating that a predetermined application or service is active, signals indicating a current wireless communication, or signals indicating the mobile device is in a predetermined venue.

### FIELD

The present application relates to control elements, and more specifically to salient control elements, such as may be used with a mobile device or other electronic device.

### BACKGROUND

Mobile devices are increasingly relied upon to perform a range of functions, including serving as a camera, a phone, a texting device, an e-reader, a navigation device, as just a few examples. The number of control elements (such as buttons and other tactile elements provided to the user) has increased. New users can become frustrated in trying to learn which buttons or other control elements control which features of the device. Because more control elements are present, there is a greater chance that an incorrect control element will be actuated.

### SUMMARY

Described below are implementations of a salient control element, as well as a mobile device with such a control element, that address shortcomings in conventional control elements and mobile devices.

In one implementation, a salient control element for a mobile device comprises at least one button actuatable by a user to execute a mobile device function. The button has at least a first active state in which the button is extended or retracted relative to a surrounding surface and a second inactive state in which the button is substantially flush with the surrounding surface. The button is reconfigurable between the active state and the inactive state based upon a triggering event. The triggering event comprises at least one of receiving signals indicating a position, motion or orientation of the device, signals indicating a mode of operation or time, signals indicating that a predetermined application or service is active, signals indicating a current wireless communication, or signals indicating the mobile device is in a predetermined venue.

The mobile device can have a front surface that includes a display, adjoining side surfaces and a back surface, and the at least one button can be provided on one of the adjoining side surfaces or the back surface.

The at least one button can be a first button, and there can be at least a second button. The first and second buttons can be positioned on an adjoining side surface and separately configurable such that the first button can be configured to extend as a shutter release button for a camera in a first mode and the first and second buttons can be configured to extend as volume control buttons in a second mode. The triggering event for the first mode can comprise inertial measurement signals indicating that the mobile device is in a landscape orientation. The triggering event for the first mode can comprise signals indicating that the mobile device is in a camera mode.

The predetermined venue can comprise a motor vehicle, an aircraft or proximity to an intelligent device. The predetermined venue can comprise presence within range of another device's near field communication range. The predetermined venue can comprise presence within range of a gaming device, and the button can be reconfigured from a retracted inactive state to an extended active state as a gaming control.

The button can comprise a microfluidicly actuated element.

The button can be a first button, and there can be at one second button. The first and second buttons can be positioned on a rear side of the device and are configured to allow the user to input characters by blind typing or swipe writing.

The button can be positioned on one side of a cover attached to the device and movable between a closed position covering a display and an open position in which the display is visible. The button can be active when the display is visible.

The button can be a first button, and there can be multiple other buttons arranged on the cover in a keyboard pattern.

According to another implementation, a salient control element for a mobile device comprises at least one control element actuatable by a user to control operation of the mobile device. The control element has at least a first active state in which the control element is tactilely discernible to a user and a second inactive state in which the control element is substantially undiscernible relative to the surrounding surface. The control element button is reconfigurable between the active state and the inactive state based upon a triggering event. The triggering event can comprise at least one of receiving signals indicating a position, motion or orientation of the device, signals indicating a mode of operation or time, signals indicating that a predetermined application or service is active, signals indicating a current wireless communication, or signals indicating the mobile device is in a predetermined venue.

The control element can comprise an element that can sense deflection. The control element can comprise an element that can sense pressure. The control element can comprise a force sensing resistive element that can sense an applied force. The control element can comprise a piezoelectric element.

According to another implementation, a salient notification element for a mobile device comprises at least one notification element having at least a first active state in which the element is extended or retracted relative to a surrounding surface and a second inactive state in which the button is substantially flush with the surrounding surface. The element is configured to change from an inactive state to an active state by extending or retracting to be tactilely detectible to the user upon occurrence of a predetermined event. The element remains in the active state until reset by the user.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

The foregoing and other objects, features, and advantages will become more apparent from the following detailed description, which proceeds with reference to the accompanying figures.

### BRIEF DESCRIPTION OF THE DRAWINGS

FIG. 1A is a schematic flow and logic diagram showing the operation of a salient control element.

FIG. 1C, FIG. 1D and FIG. 1D are schematic diagrams showing a mobile device or other electronic device with salient control elements adapted to different situations.

FIGS. 2A and 2B are schematic diagrams of a rear side of a mobile device with salient control elements according to another implementation.

FIGS. 3 and 4 are schematic diagrams of a rear side of a mobile device with salient control elements configured for additional implementations.

FIG. 5 is a schematic view of a mobile device with an attached cover having salient control elements.

FIG. 6 is a diagram of an exemplary computing environment in which the described methods and systems can be implemented.

### DETAILED DESCRIPTION

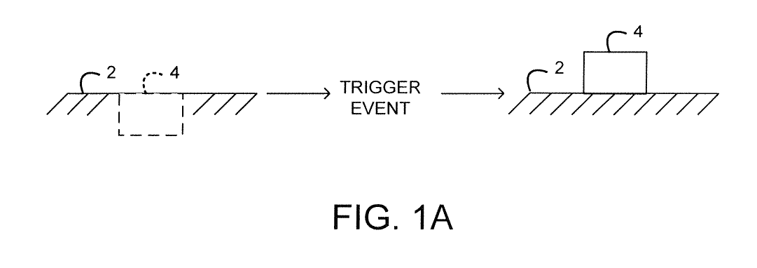

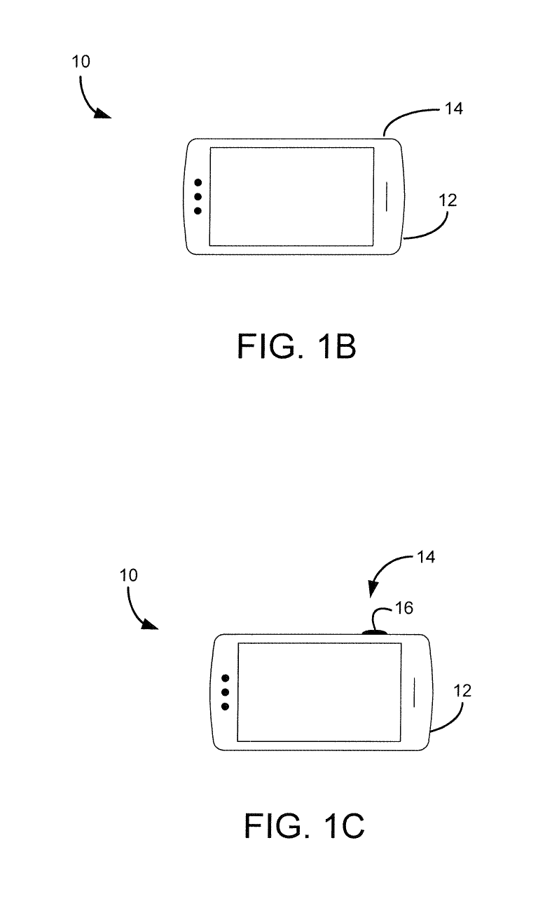

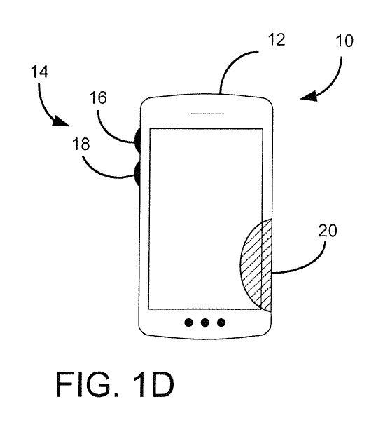

FIG. 1A is a schematic flow and logic diagram illustrating a basic salient control element 4. From left to right, the representative example of FIG. 1 shows that the salient control element 4 is in an inactive state relative to its surroundings 2 until a trigger event or condition occurs, at which time the salient control element becomes active and actuatable by a user to execute an operation, as is described below in greater detail. A “salient” control element has contextual awareness and is tactilely discernible by a user (e.g., it is raised, recessed or otherwise physically configured to be tactilely discernible relative to its surroundings) in its active state.

FIGS. 1B, 1C and 1D are schematic diagrams of a mobile device 10. In FIGS. 1B and 1C, the mobile device 10 is shown with its display 12 oriented in a landscape orientation, i.e., with the longer sides of the device approximately level with the ground. Although not required to have any specific size, the display 12 is understood to extend over substantially the entire area defined between the longer sides and the shorter sides of the device.

In the example of FIG. 1B, one of the longer sides of the device, such as the upper one of the longer sides, has a salient control element 14. Depending upon a predetermined trigger, the salient control element 14 is configured (or reconfigured) to be actuatable by the user, typically by a manual action. For example, as shown in FIG. 1C, the salient control element 14 can be a user actuatable button 16 or other form of control element configured to extend when the device 10 is in a predetermined position, orientation, mode of operation, etc. Comparing FIGS. 1B and 1C, it can be seen that the button 16 has been extended from an inactive position, such as a position flush with the side of the device as shown in FIG. 1B, to an active position, such as the extended position shown in FIG. 1C, that visibly and tactilely guides the user to orient her finger on the button 16. As is described below in more detail, the extension/retraction or other motion of the salient control element 14 is controlled by software or other instructions from a controller.

According to one example, the button 16 is configured as a shutter release actuatable to take a photograph. The trigger to configure the salient control element 14 of FIG. 1B as a shutter release can be one or more of the following: detecting that the device 10 has been rotated to position the screen 12 in the landscape orientation, detecting motion consistent with raising a camera to take a photograph, detecting that the device 10 is in a camera mode, detecting that an application or service running on the device is awaiting an image input, and/or any other suitable trigger. Rather than present the user with multiple control elements such as multiple buttons on different sides of the display, the user is guided toward a single salient control element for operating the device in its current mode (or a predicted current mode).

In one exemplary implementation, after the device 10 is turned on and its IMU is polled, it is determined whether the device is being held in a way to take a photo. If so, one or more salient control elements are configured (for example, and as described above, one or more buttons can be raised). When the operation is complete, such as when the user lowers the device, the IMU will indicate a change in position and the buttons can be rendered inactive (e.g., retracted, according to this example).

As another example, in a different context, the control element 14 can be an alarm clock/timer button that extends upon the alai in clock/timer reaching a predetermined time. In this example, the control element 14 is actuatable by the user to turn off the alarm or the timer. As examples only, the triggering event(s) can include reaching a predetermined time, having an active alarm or timer application or service running, the orientation of the device and/or whether the device is in a propped-up position.

In FIG. 1D, the device 10 is shown after it has been rotated so that the display 12 is in a portrait orientation and the salient control element 14 has been reconfigured to cause two buttons, including the button 16 and a second button 18, to extend from the side of the device. In addition, the area 20 is a schematic depiction of the user's right palm overlapping a portion of the display 12 as she holds the device 10 in the orientation shown.

The buttons 16, 18 can be configured for any suitable operation. For example, assuming the camera operation of FIG. 1C is complete, the buttons 16, 18 can be configured as volume controls, such as with the button 16 being the Decrease Volume control and the button 18 being the Increase Volume control. Thus, the button 16 has been reconfigured from its shutter release function in FIG. 1C to the Decrease Volume function. Similarly, the button 18 has been extended and configured as the Increase Volume control, whereas it was retracted and inactive in the configuration of FIG. 1C.

The trigger to change the function of the salient control element 14 to volume control for the mode of operation of FIG. 1D can be a return to a normal or default mode of operation, an initiation of a mode of operation with audio content, such as making or receiving a telephone call or listening to audio content, or any other suitable trigger.

In FIG. 1D, the area 20 is shown to indicate that the user's right palm is overlapping a portion of the display 12. Advantageously, the device 10 and the salient control element 14 can be configured to detect the palm contact 20 (e.g., palm rejection) as an indication that the user is holding the device with her right hand and thus could most conveniently actuate volume controls if positioned at the locations of the buttons 16, 18 as shown. Conversely, if the user is holding the device 10 in her left hand, then the buttons 16, 18 could be configured to extend from the opposite side of the device 10. Of course, user preferences for these and similar actions could be permitted by changes to default settings on the device and in applications and services. In this way, operation of the device 10 can be personalized for the handedness of the user, both during a current operation that might be carried out with either hand, such as answering a call, and/or on a default basis (i.e., always assume left-handed operation).

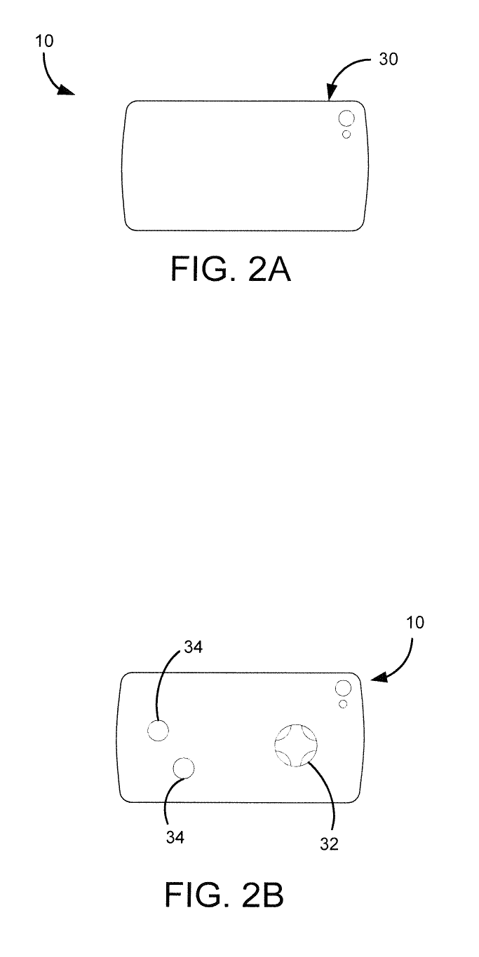

FIGS. 2A and 2B show another example of the device 10 with one or more salient control elements. In FIGS. 2A and 2B, a rear side 30 of the device, i.e., the side of the device without a display (or the side opposite the side with the primary display, in the case of devices with displays on two sides), is shown. In FIG. 2A, there are no salient control elements that are active and/or actuatable. The positions of salient control elements may be visible or invisible, but they are generally not tactilely discernible when they are not active and/or actuatable.

In FIG. 2B, multiple salient control elements have been configured to become actuatable/active on the rear side 30. For example, the control element 32 as shown on the right side of FIG. 2B can be a rocker button 32, such as is used in many gaming applications. There can be any number of additional salient control elements present, such as the control elements 34 on the left side, which in the illustrated example are configured as buttons. The configuration in FIG. 2B has many uses, including as a game controller, with the device 10 being held in both hands and the buttons 34 being actuatable with the left thumb and the rocker button 32 being actuatable with the right thumb, as just one example.

As above, appropriate triggers for reconfiguring the salient control elements 32, 34 from their inactive states in FIG. 2A to their active game controller states in the FIG. 2B example include: a change in the position of the device to the landscape orientation as shown with the display (or primary display) facing away from the user, initiation of a game mode, running a game application or service, occurrence of an event (e.g., receiving an invitation, a calendar event, a reminder, a communication from a nearby' gaming unit, etc.), etc.

In many implementations, the trigger for the device 10 to change the state of the salient control element 14 or 30 includes a position, orientation or motion of the device 10, such as is detected by the inertial measurement unit (IMU) of the device 10 or other similar circuit. The IMU detects, e.g., whether the device is in landscape or portrait orientation, whether the device is in motion or stationary, whether the device has been tilted to a predetermined angle, whether the device has been rotated by a predetermined amount about one of its axes, etc.

In addition, the trigger may include input from one or more touch-sensitive areas of the device. For example, the trigger could include detection that the user's palm is in contact with the display 12 of the device 10, as in the example of FIG. 1D. Detection of contact with touch-sensitive areas could be used in connection with IMU event detection to trigger configuration of the salient control element 14 or 30. Current touch sensitive displays can track at least ten points of contact and calculate the centroid of these points of contact.

Other examples of triggering events include an incoming wireless communication (e.g., receiving a text message, an email message or a telephone call) or a change in near field communication state (e.g., entering into or exiting from a connected near field communication state with a nearby device).

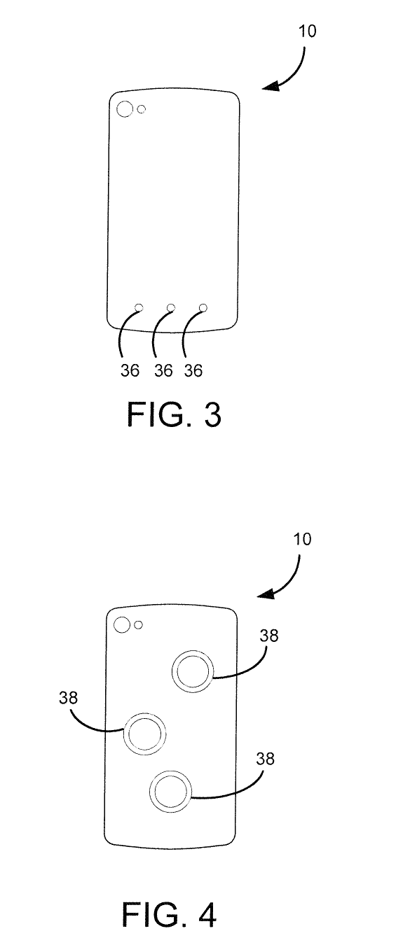

In FIG. 3, the mobile device 10 as implemented to have one or more salient control elements configured as notification indicators, is shown. In the specific example of FIG. 3, there are three notification buttons 36 that are shown in their deployed state, in which they are tactilely detectible by the user. In the specific example of FIG. 3, the deployed state of the buttons 36 is also visually detectible. The buttons 36 can be controlled to be deployed individually or in groups of two or more buttons simultaneously or sequentially. According to one implementation, the buttons 36 are configured as notification elements. Upon the occurrence of a triggering condition, one or more buttons are controlled to deploy to give the user a tactile (as well as, in some cases, visual) notification of an event. For example, one of the buttons 36 can be controlled to extend (or to retract) upon receipt of a text message. A different pattern of one or more of the buttons can be configured, e.g., to indicate receipt of a voicemail message. If implemented as shown on the rear side of the device, the notifications provided by the buttons 36 can be a discrete but convenient way to allow the user to realize that she has, e.g., received a text message, when only the rear side of the device is in view (e.g., if the device is lying face down on a table). The notifications can occur simultaneously with or instead of audio-oriented notifications, vibration-oriented notifications and/or display-oriented notifications on the display of the device.

According to one usage, the user responds to the notifications. The user can respond by manually actuating each button 36 to indicate that the user has received the notification and to reset the notification button. Alternatively, or in addition, the notification buttons can be programmed to reset automatically, e.g., to retract or to extend after a period of time, after the device is moved from its face down position, etc.

In FIG. 4, the device 10 is shown with salient control elements configured for entry of input. For example, the rear side of the device 10 can have salient control elements 38 as shown that allow the user to make inputs, e.g., to enter alphanumeric characters, to navigate a page or among fields, to select, etc. In one usage scenario, the user is viewing a display on one side of the device and is making inputs via another side of the device that may be obscured by the display. For example, the salient control elements 38 can be configured to permit entry of characters or strings of characters by blind typing, swipe writing and other similar entry techniques that employ fewer control elements than characters. For example, several control elements can be provided where each functions to enter a particular zone of characters (e.g., “qwer,” “tyu” and “iop,” could each be treated as a separate zone).

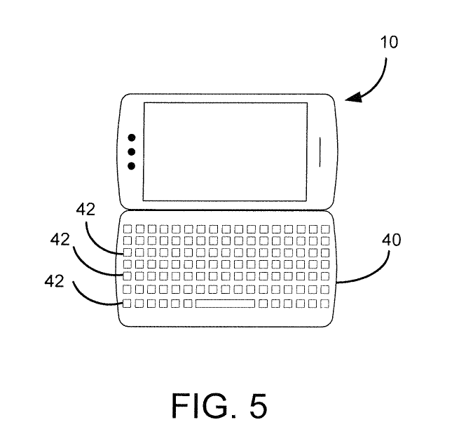

In FIG. 5, the device 10 is shown with a cover 40 having one or more salient control elements. In FIG. 5, the cover 40 is shown in an open position, pivoted away from the device, and allowing the display to be seen. According to one implementation, salient control elements 42, three of which are specifically identified in the figure, are configured as keys in a keyboard pattern. Although a full keyboard is illustrated schematically, it would of course be possible to implement just a handful of control elements where each element is actuatable to enter multiple different characters, as is described above. The cover 40 can be provided with additional salient control elements on its reverse side (not shown), which is the outer side of the cover 40 when it is in the closed portion covering the device 10.

Concerning other aspects relating to trigger events and conditions, a mobile device can be configured to cause one or more salient control elements to be activated based on the location of the mobile device and or the mobile device's proximity to another intelligent device. For example, the mobile device can be configured to cause salient control elements to become active when the user is present at a location associated with the user through a software application on the mobile device or service. As just one example, when the user leaves or arrives at her residence, salient control elements are presented for arming or disarming a security system or home automation program. Such salient control elements could include one or more rear side control elements that protrude from or are recessed from the rear surface. As another example, the salient control elements can be configured, upon detection of a nearby TV, to be configured into controls for the TV. For example, salient control elements on a rear side of a mobile device could become active upon entering within a predetermined range of a connected TV. More generally, the salient control elements can be configured to be responsive to other intelligent devices within a predetermined range, or other devices connected to the mobile device, such as by near field and other types of communication.

Similarly, the salient control elements can be configured to respond to other specific venues. For example, one or more salient control elements can be configured to become active while the user of the mobile device is driving an automobile, e.g., to present a reduced command set for safe but effective operation. In another example, the salient control elements may be configured to provide access to only limited device functions, e.g., if it is detected that the user is using the mobile device on an aircraft.

In some implementations, the salient control elements 14 and 30 are implemented as controllable microfluidic members capable of being reconfigured by instructions from a controller. For example, the described buttons can be configured to extend or retract as required by changing the fluid pressure and/or in associated fluid circuits. Such fluid circuits can be configured to operate using liquids, gases or a combination thereof. In some implementations, the user's multiple contacts with (e.g., a repeated taps) or other actions involving the control elements cause a pumping action that extends or retracts at least one control element.

In some implementations, other approaches are used to provide buttons or other control elements having at least two states, i.e., an active state and an inactive state. Desirably, a button in the active state has a highly tactile character and is distinguishable from a button in an inactive state. In addition to control elements characterized as “buttons,” it is also possible to configure them to have at least one tactilely perceptible edge.

In some implementations, the degree of deflection and/or pressure exerted by a user at a specified location is detected and/or measured, and if above a threshold, a contact is registered. In some implementations, the detected or measured contact includes a user's sliding motion.

The control elements can be implemented using artificial muscle, which is defined herein to describe materials and/or devices that expand, contract, rotate or otherwise move due to an external stimulus, such as voltage, current, pressure or temperature. Such materials and devices include electro-active polymers, dielectric elastomer actuators, relaxor ferroelectric polymers, liquid crystal elastomers, pneumatic artificial muscles, ionic polymer metal composites, shape memory alloys, and electric field-activated electrolyte-free artificial muscles, to name a few examples.

In addition, capacitive touch panel, electromagnetic induction touch panel and other similar technologies can be employed to implement the control elements and related components. Force sensing resistive elements and/or piezoelectric electric elements can be used.

In some implementations, there are cues that provide the user sufficient information as to the current function of the salient control elements. For example, if other indications show that the device is in a camera mode, then a single raised button provided in the usual location of the shutter release button (see FIG. 1C) may not need to be specifically identified. On the other hand, if multiple buttons are present or if the current function of a button or other control is not intuitive, then the button's current function can be indicated, such as on an associated display. For the embodiments of FIG. 1B-1D with the buttons 16, 18 on the side of the device 10, for example, a separate display can be provided on the side of the device or a portion of the display 12 can be used to identify the buttons 16, 18. For example, a display that uses electronic paper can be used.

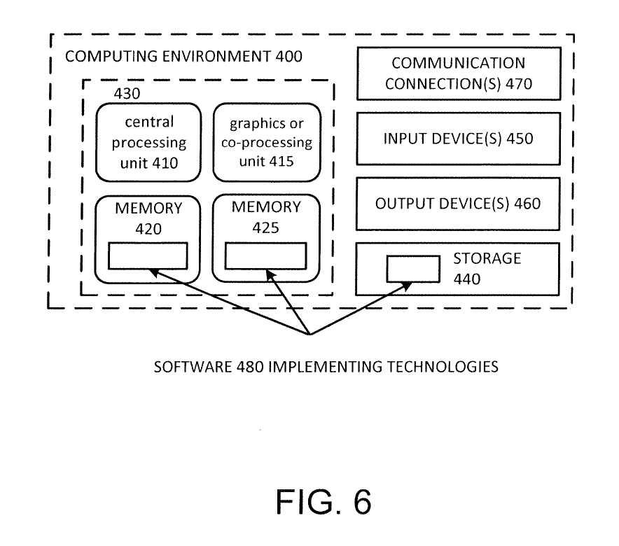

FIG. 6 illustrates a generalized example of a suitable computing system 400 in which several of the described innovations may be implemented. The computing system 400 is not intended to suggest any limitation as to scope of use or functionality, as the innovations may be implemented in diverse general-purpose or special-purpose computing systems.

With reference to FIG. 6, the computing system 400 includes one or more processing units 410, 415 and memory 420, 425. In FIG. 6, this basic configuration 430 is included within a dashed line. The processing units 410, 415 execute computer-executable instructions. A processing unit can be a general-purpose central processing unit (CPU), processor in an application-specific integrated circuit (ASIC) or any other type of processor. In a multi-processing system, multiple processing units execute computer-executable instructions to increase processing power. For example, FIG. 6 shows a central processing unit 410 as well as a graphics processing unit or co-processing unit 315. The tangible memory 420, 425 may be volatile memory (e.g., registers, cache, RAM), non-volatile memory (e.g., ROM, EEPROM, flash memory, etc.), or some combination of the two, accessible by the processing unit(s). The memory 420, 425 stores software 480 implementing one or more innovations described herein, in the form of computer-executable instructions suitable for execution by the processing unit(s).

A computing system may have additional features. For example, the computing system 400 includes storage 440, one or more input devices 450, one or more output devices 460, and one or more communication connections 370. An interconnection mechanism (not shown) such as a bus, controller, or network interconnects the components of the computing system 400. Typically, operating system software (not shown) provides an operating environment for other software executing in the computing system 400, and coordinates activities of the components of the computing system 400.

The tangible storage 440 may be removable or non-removable, and includes magnetic disks, magnetic tapes or cassettes, CD-ROMs, DVDs, or any other medium which can be used to store information in a non-transitory way and which can be accessed within the computing system 400. The storage 440 stores instructions for the software 480 implementing one or more innovations described herein.

The input device(s) 450 may be a touch input device such as a keyboard, mouse, pen, or trackball, a voice input device, a scanning device, or another device, having one or more salient control elements, that provides input to the computing system 400. For video encoding, the input device(s) 450 may be a camera, video card, TV tuner card, or similar device that accepts video input in analog or digital form, or a CD-ROM or CD-RW that reads video samples into the computing system 400. The output device(s) 460 may be a display, printer, speaker, CD-writer, or another device that provides output from the computing system 400

The communication connection(s) 470 enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

The innovations can be described in the general context of computer-executable instructions, such as those included in program modules, being executed in a computing system on a target real or virtual processor. Generally, program modules include routines, programs, libraries, objects, classes, components, data structures, etc. that perform particular tasks or implement particular abstract data types. The functionality of the program modules may be combined or split between program modules as desired in various embodiments. Computer-executable instructions for program modules may be executed within a local or distributed computing system.

For the sake of presentation, the detailed description uses terms like “determine” and “use” to describe computer operations in a computing system. These terms are high-level abstractions for operations performed by a computer, and should not be confused with acts performed by a human being. The actual computer operations corresponding to these terms vary depending on implementation.

In view of the many possible embodiments to which the disclosed principles may be applied, it should be recognized that the illustrated embodiments are only preferred examples and should not be taken as limiting in scope. Rather, the scope is defined by the following claims.

We claim:

1. A salient control element for a mobile device, comprising:
at least one button actuatable by a user to execute a mobile device function, the button having at least a first active state in which the button is extended or retracted relative to a surrounding surface and a second inactive state in which the button is substantially flush with the surrounding surface,
wherein the button is reconfigurable between the active state and the inactive state based upon a triggering event, wherein the triggering event comprises at least one of receiving signals indicating a position, motion or orientation of the device, signals indicating a mode of operation or time, signals indicating that a predetermined application or service is active, signals indicating a current wireless communication, or signals indicating the mobile device is in a predetermined venue.

2. The salient control element of claim 1, wherein the device has a front surface that includes a display, adjoining side surfaces and a back surface, and wherein the at least one button is provided on one of the adjoining side surfaces or the back surface.

3. The salient control element of claim 1, wherein the at least one button is a first button, further comprising a second button, and wherein the first and second buttons are positioned on an adjoining side surface and are separately configurable such that the first button can be configured to extend as a shutter release button for a camera in a first mode and the first and second buttons can be configured to extend as volume control buttons in a second mode.

4. The salient control element of claim 3, wherein the triggering event for the first mode comprises inertial measurement signals indicating that the mobile device is in a landscape orientation.

5. The salient control element of claim 3, wherein the triggering event for the first mode comprises signals indicating that the mobile device is in a camera mode.

6. The salient control element of claim 1, wherein the predetermined venue comprises a motor vehicle, an aircraft or proximity to an intelligent device.

7. The salient control element of claim 1, wherein the button comprises a microfluidicly actuated element.

8. The salient control element of claim 1, wherein the button is a first button and there is at least a second button, wherein the first and second buttons are positioned on a rear side of the device and are configured to allow the user to input characters by blind typing or swipe writing.

9. The salient control element of claim 1, wherein the button is positioned on one side of a cover attached to the device and movable between a closed position covering a display and an open position in which the display is visible.

10. The salient control element of claim 9, wherein the button is active when the display is visible.

11. The salient control element of claim 9, wherein the button is a first button, further comprising multiple other buttons arranged on the cover in a keyboard pattern.

12. The salient control element of claim 1, wherein the predetermined venue comprises presence within range of another device's near field communication range.

13. The salient control element of claim 12, wherein the predetermined venue comprises presence within range of a gaming device, and the button is reconfigured from a retracted inactive state to an extended active state as a gaming control.

14. A salient control element for a mobile device, comprising:
at least one control element actuatable by a user to control operation of the mobile device, the control element having at least a first active state in which the control element is tactilely discernible to a user and a second inactive state in which the control element is substantially undiscernible relative to the surrounding surface,
wherein the control element button is reconfigurable between the active state and the inactive state based upon a triggering event, wherein the triggering event comprises at least one of receiving signals indicating a position, motion or orientation of the device, signals indicating a mode of operation or time, signals indicating that a predetermined application or service is active, signals indicating a current wireless communication, or signals indicating the mobile device is in a predetermined venue.

15. The salient control element of claim 14, wherein the control element comprises a microfluidicly actuated element.

16. The salient control element of claim 14, wherein the control element comprises an element that can sense deflection.

17. The salient control element of claim 14, wherein the control element comprises an element that can sense pressure.

18. The salient control element of claim 14, wherein the control element comprises a force sensing resistive element that can sense an applied force.

19. The salient control element of claim 14, wherein the control element comprises a piezoelectric element.

20. A salient notification element for a mobile device, comprising:
at least notification element having at least a first active state in which the element is extended or retracted relative to a surrounding surface and a second inactive state in which the button is substantially flush with the surrounding surface,
wherein the element is configured to change from an inactive state to an active state by extending or retracting to be tactilely detectible to the user upon occurrence of a predetermined event, and wherein the element remains in the active state until reset by the user.
